(19) United States
(12) Patent Application Publication
(10) Pub. No.: US 2011/0153961 A1
(43) Pub. Date: Jun. 23, 2011

(54) STORAGE DEVICE WITH FUNCTION OF VOLTAGE ABNORMAL PROTECTION AND OPERATION METHOD THEREOF

(75) Inventors: Hao-Po Chao, Chung Ho City (TW); Chung-Hsun Lee, Chung Ho City (TW)

(73) Assignee: A-DATA TECHNOLOGY (SUZHOU) CO., LTD., SuZhou (CN)

(21) Appl. No.: 12/797,604

(22) Filed: Jun. 9, 2010

(30) Foreign Application Priority Data
Dec. 23, 2009 (CN) 200910264744.3

(51) Int. Cl. G06F 1/26; G06F 12/00

(52) U.S. Cl. 711/154; 713/300; 711/E12.001

(57) ABSTRACT

The present invention discloses a storage device and an operation method thereof. The storage device includes a non-volatile memory for storing data, a control unit coupled to the non-volatile memory, a power supply unit coupled to an external power source and converting the external power source to a suitable voltage for the non-volatile memory and the control unit, and a power monitor unit for monitoring the external power source. When the external power source falls below a low voltage threshold of the non-volatile memory, a control signal is transmitted into the control unit so as to stop accessing the non-volatile memory. The non-volatile memory finishes the last processing procedure according to the last programming instruction sent by the control unit before the control signal for protecting the data stored in the non-volatile memory.

### BACKGROUND OF THE INVENTION

1. Field of the Invention

The present invention relates to electronic storage devices and operation methods thereof, and more particularly to non-volatile electronic storage devices with functions of voltage abnormal protection and operation methods of such non-volatile electronic storage devices.

2. Description of Related Art

Electronic memory devices can be roughly classified into volatile and nonvolatile ones. Volatile memory devices allow high speed read and write operations, but lose data when disconnected from an external power source. On the other hand, nonvolatile memory devices retain stored information even when disconnected from an external power source. As is known, flash memories are common forms of the nonvolatile memory devices and are widely used in electronic products as data storages because of their high speed of read and write, power save and high reliabilities etc.

Usually, a nonvolatile memory device receives a power from an external power source and then converts the external power source to suitable working voltage for the nonvolatile memory device. A control unit of the nonvolatile memory device is adapted for receiving operation instructions sent by a host device to which the nonvolatile memory device connects. According to such operation instructions, the nonvolatile memory device handles data exchanges with the host device.

However, if an error, such as power failure, occurs when the nonvolatile memory device is in normal working status, the working memory page of the nonvolatile memory device may be incomplete during processes of writing data or erasing data. As a result, the nonvolatile memory device may be destroyed due to the following possibilities. Firstly, the data planned to be stored in the memory page is destroyed; Secondly, the data which has already been stored in the memory page is destroyed because of such error; Thirdly, potential unreliable memory pages which can't work anymore, may come into being caused by the incomplete memory page; Fourthly, the nonvolatile memory device doesn't work anymore because that the management data thereof has been destroyed.

Hence, an improved storage device and an improved operation method thereof with functions of voltage monitoring and voltage abnormal protection are needed to solve the problems above.

### BRIEF SUMMARY OF THE INVENTION

The present invention discloses a storage device and an operation method thereof. The storage device with a function of voltage abnormal protection includes a non-volatile memory for storing data, a control unit, a power supply unit and a power monitor unit for monitoring the external power source. The control unit is electrically coupled to the non-volatile memory in order to access the non-volatile memory. The power supply unit is electrically coupled to an external power source and converts the external power source to a suitable voltage for working of the non-volatile memory and the control unit. The power monitor unit connects the external power source and the power supply unit. The power monitor unit is located between the external power source and the power supply unit. The power monitor unit is electrically coupled to the control unit. When the external power source falls below a low voltage threshold of the non-volatile memory, a control signal is transmitted into the control unit so as to stop accessing the non-volatile memory. The non-volatile memory finishes the last processing procedure according to the last programming instruction sent by the control unit before the control signal for protecting the data stored in the non-volatile memory.

A method for operating a storage device with a non-volatile memory and a control unit includes steps of: a) receiving a voltage of an external power source; b) converting the voltage of the external power source to a suitable voltage for working of the non-volatile memory and the control unit; and c) monitoring the voltage of the external power source. When the voltage of the external power source falls below a low voltage threshold (Vₜₕ) of the non-volatile memory, a control signal is transmitted into the control unit so as to stop accessing the non-volatile memory. Before stop accessing the non-volatile memory, the non-volatile memory finishes the last processing procedure according to the last programming instruction sent by the control unit before the control signal for protecting the data stored in the non-volatile memory.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a schematic block diagram representation of a storage device in accordance with an embodiment of the present invention;

FIG. 2 is an operation sequence diagram of the storage device in accordance with an embodiment of the present invention; and

FIG. 3 is a flowchart representation a method for operating the storage device in accordance with an embodiment of the present invention.

### DETAILED DESCRIPTION OF THE PREFERRED EMBODIMENT

Reference will now be made to the drawing figures to describe the embodiments of the present invention in detail. In the following description, the same drawing reference numerals are used for the same elements in different drawings.

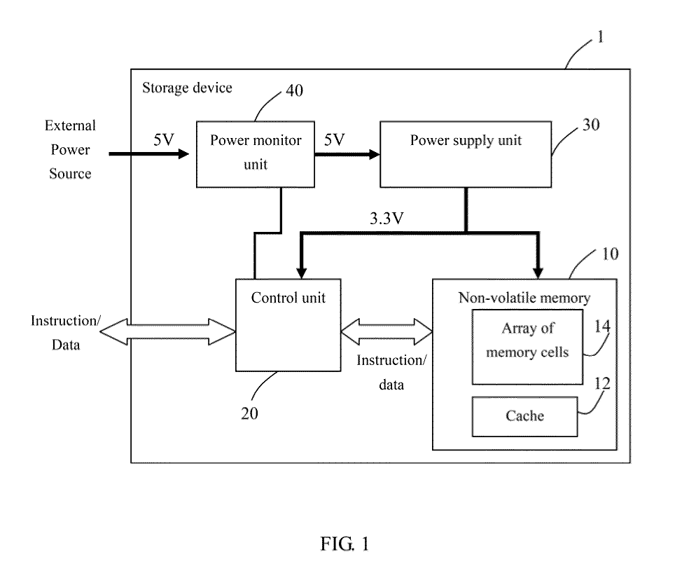

Referring to FIG. 1, a storage device 1 in accordance with an embodiment of the present invention is disclosed. The storage device 1 includes a non-volatile memory 10 for storing data, a control unit 20 electrically coupled to the non-volatile memory 10, a power supply unit 30 and a power monitor unit 40. The storage device 1 is connectable to a peripheral host device, such as a computer system (not shown), for executing instructions/data sent by the host device in order to access the non-volatile memory 10 via the control unit 20.

The power supply unit 30 is electrically coupled to an external power source for receiving a voltage thereof. The power supply unit 30 includes a voltage converting circuit and/or a voltage stabilizing circuit. The voltage converting circuit adjusts the voltage of the external power source to a suitable working voltage provided for the non-volatile memory 10 and the control unit 20. The voltage stabilizing circuit is adapted for invariably keeping the suitable working voltage. According to the embodiment of the present invention, a 5 volt voltage of the external power source is converted to a 3.3 volt voltage by the voltage converting circuit such as a DC-to-DC converting circuit. The 3.3 volt voltage is a suitable working voltage of the non-volatile memory 10 and the control unit 20. The voltage stabilizing circuit keeps the 3.3 volt voltage invariably in spite of the fluctuation of the external power source so that the non-volatile memory 10 and the control unit 20 can work in normal status.

The power monitor unit 40 is located between the external power source and the power supply unit 30, and is electrically connected to the control unit 20. When the voltage of the external power source is detected falling below a low voltage threshold (Vₜₕ) of the non-volatile memory 10, a control signal is then transmitted into the control unit 20 so as to stop accessing the non-volatile memory 10. According to the embodiment of the present invention, the control signal is a reset signal indicating that the control unit 20 is going to be reset, or a busy signal indicating that the non-volatile memory 10 is busy. However, it is easy to those of ordinary skill in the art to realize that the control signal can be of other types' description of which are omitted hereinafter.

As shown in FIG. 1, the non-volatile memory 10 includes a cache 12 and an array of memory cells 14. The non-volatile memory 10 finishes the last processing procedure according to the last operation instruction sent just before the control signal. The processing procedure is writing data or erasing data. Take the writing data procedure for example, even if the voltage of the external power source falls below the low voltage threshold (Vₜₕ), the non-volatile memory 10 can still copy data which has been prestored in the cache 12, to the memory cells 14. However, this copy procedure is the last processing procedure and the following processing procedure is stopped because the control unit 20 doesn't access the non-volatile memory 10 anymore.

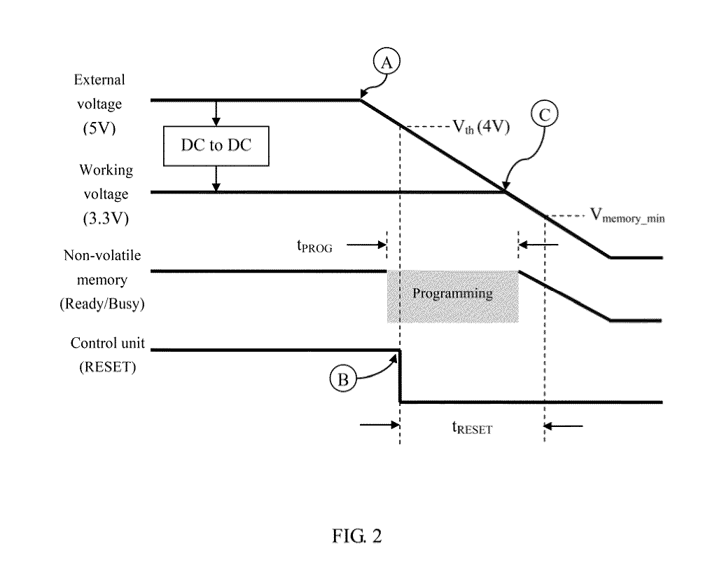

Referring to FIG. 2, an operation sequence diagram of the storage device 1 is disclosed. In the event of an error, such as power failure, as shown at point A, the power monitor unit 40 detects that the voltage (5 volts for example) of the external power source decreases gradually. Because the power supply unit 30 can stabilize the voltage, under this condition, the working voltage (3.3 volts for example) of the non-volatile memory 10 and the control unit 20 can still be provided. When the voltage of the external power source decreases from 5 volts to fall below the low voltage threshold (Vₜₕ), such as 4 volts, a control signal is given by the power monitor unit 40 to the control unit 20. The control signal indicates that accessing the non-volatile memory 10 must be stopped.

When the control unit 20 sends an operation instruction to stop accessing the non-volatile memory 10 as shown at point B. Take a reset signal as the control signal for the following description. Corresponding to point B, the working voltage (3.3 volts for example) of the non-volatile memory 10 can still be provided, as described above. Then, the voltage of the external power source further decreases till the power supply unit 30 can't provide the working voltage for the non-volatile memory 10 as shown at point C. However, even if the voltage provided for the non-volatile memory 10 is decreasing, the intrinsic processing procedure of the non-volatile memory 10 can still works as long as the voltage of the external power source is still much higher than the minimum working voltage (V_{memory}_{_{—}}ₘᵢₙ) of the non-volatile memory 10.

Take the procedure of writing data for example, once a programming instruction is received by the non-volatile memory 10 before the control signal which indicates stop accessing the non-volatile memory 10, the data prestored in the cache 12 can still be copied to the memory cells 14 before the voltage of the external power source falling below the minimum working voltage (V_{memory}_{_{—}}ₘᵢₙ). As shown in FIG. 2, the time (t_{RESET}) of the voltage decreasing from the Vₜₕ to the V_{memory}_{_{—}}ₘᵢₙ is enough for copying the data prestored in the cache 12 to the memory cells 14. That is to say, the time (t_{RESET}) is much longer than the time (t_{PROG}) which is used for copying the data from the cache 12 to the memory cells 14. As a result, the non-volatile memory 10 can finish the last processing procedure. According to the present invention, even if the external power source occurs an error, such as power failure, the last processing procedure of the non-volatile memory 10 can still be finished as a result that the instructions/data stored in the non-volatile memory 10 can be protected.

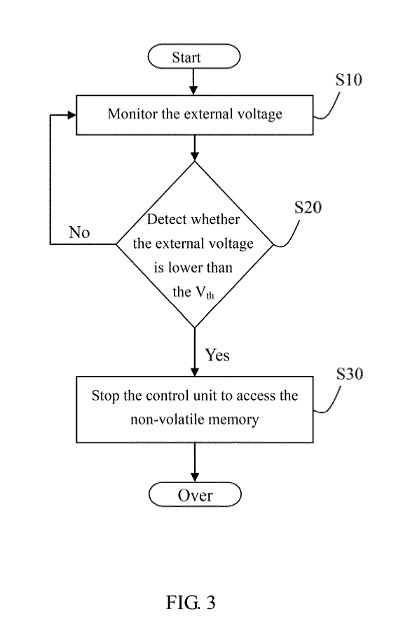

Referring to FIG. 3, a method for operating the storage device 1 comprises the steps of: firstly, receiving a voltage of an external power source (step 10); secondly, determining whether the voltage of the external power source is lower than the Vₜₕ or not (step 20); If the voltage of the external power source doesn't fall below the Vₜₕ, the step returns back to the step 10. If an error occurs and the voltage of the external power source falls below the Vₜₕ, a control signal is transmitted into the control unit 20 in order to stop accessing the non-volatile memory 10 (step 30). However, the non-volatile memory finishes a processing procedure according to the last instruction sent by the control unit 20 before the voltage of the external power source decreases to fall below the V_{memory}_{_{—}}ₘᵢₙ. As a result, the data stored in the non-volatile memory 10 can be protected without doubt.

According to the embodiment of the present invention, the non-volatile memory 10 is selected, alone or in combination, from flash memory, phase change memory (PCM), ferroelectric random access memory (FeRAM) and magnetic random access memory (MRAM).

Besides, in order to cost down, at least one of the power supply unit 30 and the power monitor unit 40 is packaged with the control unit 20 in a single chip.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A storage device with a function of voltage abnormal protection, comprising:
a non-volatile memory for storing data;
a control unit electrically coupled to the non-volatile memory in order to access the non-volatile memory;
a power supply unit electrically coupled to an external power source and converting the external power source to a suitable voltage for working of the non-volatile memory and the control unit; and
a power monitor unit connecting the external power source and the power supply unit, the power monitor unit being located between the external power source and the power supply unit, the power monitor unit being electrically coupled to the control unit and monitoring the external power source; wherein
when the external power source falls below a low voltage threshold (Vₜₕ) of the non-volatile memory, a control signal is transmitted into the control unit so as to stop accessing the non-volatile memory; and wherein
the non-volatile memory finishes the last processing procedure according to the last programming instruction sent by the control unit, the last programming instruction being sent just before the control signal.

2. The storage device according to claim 1, wherein the non-volatile memory comprises a cache and an array of memory cells for storing data, the data prestored in the cache can still be copied to the memory cells before the voltage of the external power source falls below a minimum working voltage (V_{memory}_{_{—}}ₘᵢₙ) of the non-volatile memory.

3. The storage device according to claim 2, wherein a time (t_{RESET}) of the voltage of the external power source decreasing from the low voltage threshold (Vₜₕ) to the minimum working voltage (V_{memory}_{_{—}}ₘᵢₙ) is much longer than another time (t_{PROG}) for copying the data from the cache to the memory cells.

4. The storage device according to claim 1, wherein the last processing procedure is writing data.

5. The storage device according to claim 1, wherein the last processing procedure is erasing data.

6. The storage device according to claim 1, wherein the control signal is a reset signal indicated that the control unit is going to be reset.

7. The storage device according to claim 1, wherein the control signal is a busy signal indicated that the non-volatile memory is busy.

8. The storage device according to claim 1, wherein the power supply unit comprises at least one of a voltage converting circuit and a voltage stabilizing circuit.

9. The storage device according to claim 8, wherein the power supply unit comprises both the voltage converting circuit and the voltage stabilizing circuit.

10. The storage device according to claim 1, wherein the non-volatile memory is selected, alone or in combination, from flash memory, phase change memory, ferroelectric random access memory and magnetic random access memory.

11. The storage device according to claim 1, wherein at least one of the power supply unit and the power monitor unit is packaged with the control unit in a single chip.

12. An operation method of a storage device with a non-volatile memory and a control unit, comprising steps of:
a) receiving a voltage of an external power source;
b) converting the voltage of the external power source to a suitable voltage for working of the non-volatile memory and the control unit; and
c) monitoring the voltage of the external power source; wherein
when the voltage of the external power source falls below a low voltage threshold (Vₜₕ) of the non-volatile memory, a control signal is transmitted into the control unit so as to stop accessing the non-volatile memory; and wherein
before stop accessing the non-volatile memory, the non-volatile memory finishes the last processing procedure according to the last programming instruction sent by the control unit, the last programming instruction being sent just before the control signal.

13. The operation method according to claim 12, wherein the processing procedure is writing data.

14. The operation method according to claim 12, wherein the processing procedure is erasing data.

15. The operation method according to claim 12, wherein the control signal is a reset signal indicated that the control unit is going to be reset.

16. The operation method according to claim 12, wherein the control signal is a busy signal indicated that the non-volatile memory is busy.

17. The operation method according to claim 12, further comprising a voltage stabilizing process in the step b).

18. The operation method according to claim 12, wherein the non-volatile memory comprises a cache and an array of memory cells for storing data, the data prestored in the cache can still be copied to the memory cells before the voltage of the external power source falls below a minimum working voltage (V_{memory}_{_{—}}ₘᵢₙ) of the non-volatile memory.

19. The operation method according to claim 18, wherein a time (t_{RESET}) of the voltage of the external power source decreasing from the low voltage threshold (Vₜₕ) to the minimum working voltage (V_{memory}_{_{—}}ₘᵢₙ) is much longer than another time (t_{PROG}) for copying the data from the cache to the memory cells.

20. The operation method according to claim 12, wherein the non-volatile memory is selected, alone or in combination, from flash memory, phase change memory, ferroelectric random access memory and magnetic random access memory.
